(19) United States
(12) Patent Application Publication
(10) Pub. No.: US 2018/0012223 A1
(43) Pub. Date: Jan. 11, 2018

(54) METHODS AND COMPUTER SYSTEMS FOR IMPLEMENTING A PAYMENT CARD NETWORK

(71) Applicant: MasterCard International Incorporated, Purchase, NY (US)

(72) Inventor: Ashish Yeshwant Bhosale, Pune (IN)

(21) Appl. No.: 15/631,048

(22) Filed: Jun. 23, 2017

(30) Foreign Application Priority Data
Jul. 5, 2016 (SG) 10201605514R

(51) Int. Cl. G06Q 20/40

(52) U.S. Cl. CPC G06Q 20/409; G06Q 20/4018

(57) ABSTRACT

A computer-implemented method of operating a payment card network is proposed in which the expiry date of each payment card is stored, not on or in the payment cards themselves, but as a payment card record within an electronic database. When the payment card is used, the record is accessed using other payment card details to check that expiry date has not passed. The process does not require that the expiry date is read from the payment card. This has the advantage that the payment card does not have to be replaced at the expiry date. Instead, the expiry date can be updated by updating the record. In place of the expiry date, the card has an auxiliary date which is the birthdate of the consumer in the YYMM format.

### CROSS-REFERENCE TO RELATED APPLICATION

This application is a U.S. National Stage filing under 35 U.S.C. §119, based on and claiming benefit of and priority to SG Patent Application No. 10201605514R filed Jul. 5, 2016.

### SUMMARY OF THE INVENTION

The present invention relates to methods and computer systems for implementing a payment card network, which permits consumers associated with one or more corresponding payment cards to make payments to merchants.

### BACKGROUND OF THE INVENTION

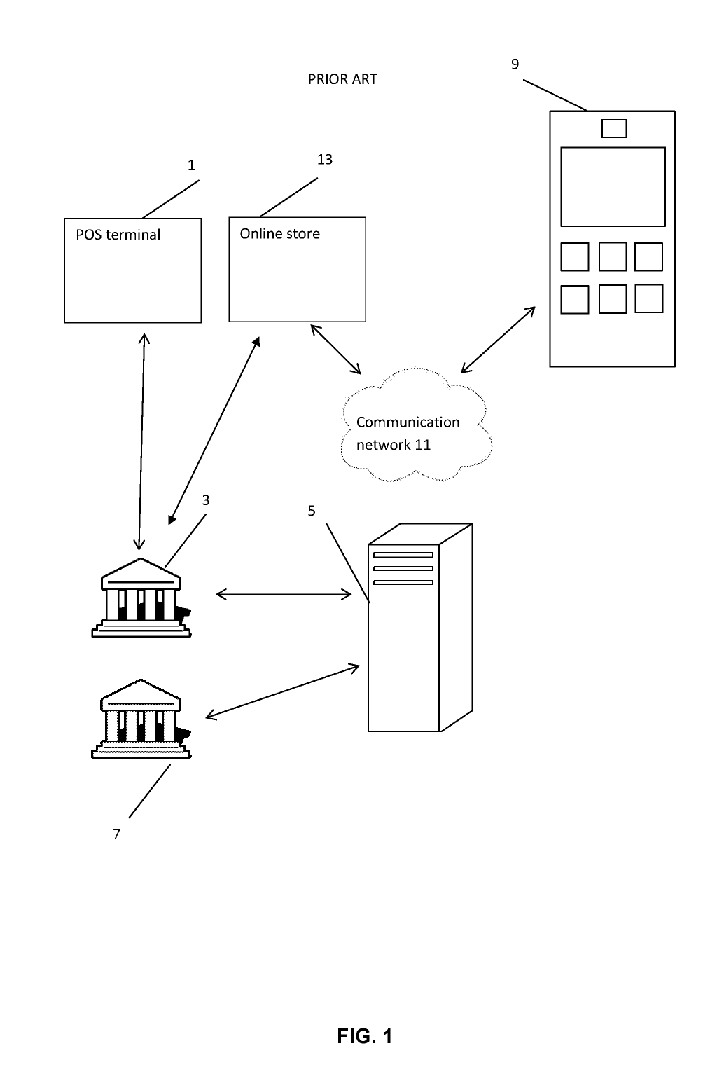

Payment cards used by individual card holders (here “consumers”) are conventionally associated with a payment network. FIG. 1 shows the basic operation of a conventional payment system. A consumer holds a payment card, typically a credit or debit card, issued by an issuer bank. The payment card is associated with a payment network. One way of using the payment card is for the consumer to go to a POS (point-of-sales) terminal 1 operated by a merchant to make a payment transaction to purchase a product. Note that the term “product” is used in this document to include any of physical objects, data products (such as music or software) or services. The POS terminal 1 reads details of the payment card from an electromagnetically readable element of the payment card, such as a magnetic strip formed on the payment card, or an integrated circuit (such as an EMV chip) embedded in the card. The POS terminal 1 includes the details of the payment card in transaction data describing the proposed payment transaction. The transaction data also includes the amount of the purchase and typically other data (e.g. the identity of the POS terminal 1). The POS terminal 1 sends a payment authorization request including the transaction data to the server 3 of an acquirer bank at which the merchant maintains an account. The acquirer bank server 3 contacts a payment network server 5 of the payment network, and passes on the payment authorization request. The payment network server 5 uses the payment card details to identify the issuer bank. The payment network server 5 contacts an issuer bank server 7 operated by the issuer bank, and sends it the payment authorization request. The issuer bank server 7 performs an authorization procedure (in which for example it checks whether the consumer's account balance is large enough to make the payment) to decide either to authorize the payment, or not to. The issuer bank server 7 sends a corresponding message to the payment network server 5. The payment network server 5 passes this information to the acquirer bank server 3, which passes the message back to the POS terminal 1. If the issuer bank server 7 authorized the payment, then the purchase is now completed. At some later time (during clearing and settlement operations), the issuer bank transfers the payment amount, less a fee, to the acquirer bank. Note that in a variant of the process, the acquirer bank server 3 is replaced by a gateway server of a third-party organization, but the operation of the gateway server is equivalent to that of the acquirer bank server described above.

The same basic scheme is used when the consumer, instead of using the POS terminal 1, uses a communication device 9 associated with the consumer to contact, using a communication network 11, a server 13 which functions as an online store. The communication device may be a smart phone, a tablet computer or a PC. In this case, the online store server 13 replaces the POS terminal 1 in the payment process described in the preceding paragraph. The consumer enters the payment card details into the communication device 9, or they may be pre-stored there.

Another common use scenario for the payment card is to withdraw money from an ATM (automatic transaction machine) operated by a bank. Let us suppose that the bank is the one which operates the server 3. The ATM reads the card data from the payment card, receives a PIN number (personal identity number) input by the consumer, and passes this data to the server 3. The server 3 sends a payment authorization request to a payment network server 5, requesting authorization to dispense money to the consumer. The payment network server 5 forwards the payment authorization request to the issuer bank server 7, and the decision of the issuer bank server 7 is communicated via the payment network server 5 to the server 3.

The payment card details present on a payment card are defined by a standard called ISO 8583. The payment card details include a primary account number (PAN, which is typically 16 digits long), an expiry date of the card and a CVV (card verification value) number. The CVV (also called sometimes a card security code (CSC) or card validation code (CVC)) is formed from the expiry date (stated as a specific month of a specific year) and the PAN number using an algorithm known to the issuer bank but otherwise confidential.

There are several types of CVV. A first, known as CVV1 (or CVC1) is encoded on track 2 of a magnetic strip of the payment card (and in some cards, stored also in an integrated-circuit smart card incorporated in the payment card). Conventionally, the magnetic strip (and/or smart card) also stores the PAN number and card expiry date. The CVV1 is used for “card present” transactions, in which the payment card is used at a point-of-sale (POS) terminal 1 or ATM. The POS terminal 1 or ATM reads the CVV1 code, PAN number and card expiry date.

A second type of CVV, is known as CVV2 (or CVC2). Merchants have the option of asking the card holder for the CVV2 in the case of “card-not-present” transactions (e.g. transactions occurring by mail, telephone or the internet).

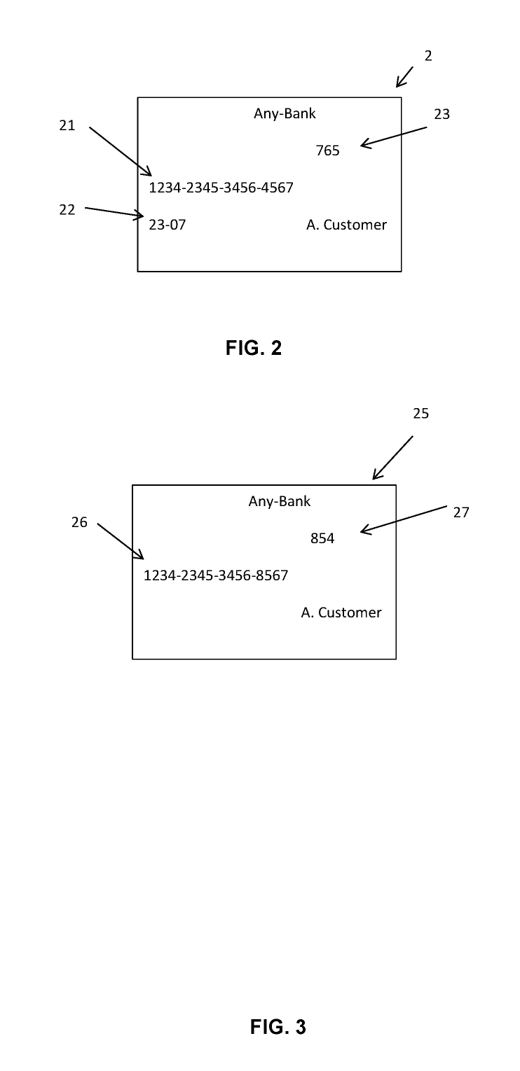

Certain card details are visible on the payment card. This is illustrated in FIG. 2 which shows a known payment card issued by a payment card issuer (“Any-Bank”) to a customer (“A. Customer”). The payment card is embossed with the PAN number 21 and expiry date 22 (in a YY-MM format, where YY is a two digit number in the range 00 to 99, and MM is a two digit number in the range 00 to 12). The CVV2 code 23 is printed on the payment card (often on the back surface of the payment card), but is not embossed (i.e. the CVV2 code is printed substantially co-planar with the surface of the payment card, not upstanding from it).

The card can only be used at times up to the end of the month which is the expiry date. Shortly before the expiry date, the issuer bank checks the credit status of the individual, and decides whether to issue a new payment card to the consumer, and whether to impose any conditions on the use of the payment card (e.g. in the case of a credit card, change a credit limit of the card). Thus, the expiry date provides a way of ensuring that the payment card cannot be used indefinitely, and that appropriate changes to the conditions of use of the card are made periodically.

### SUMMARY OF THE INVENTION

In general terms, the present invention proposes that the expiry date of a physical payment card is stored within an associated payment card record stored in an electronic database. The payment card record is accessible using other payment card details stored by the payment card (referred to as account data). The payment card is used to form payment authorization requests, which are processed in a procedure which includes checking the payment card record to ensure that the expiry date has not passed. After a certain time has passed, the expiry date in the payment card record is updated to an “extended expiry date”. Whenever the consumer (card holder) wishes to make a payment using the payment card after the updating of the expiry date, a further payment authorization request is generated using the payment card, and processed by the payment network and/or issuer bank without requiring that the further payment authorization request includes the extended expiry date. In other words, the same payment card is used to form payment authorization requests both before and after the updating of the expiry date.

This has the advantage that the payment card does not have to be replaced when the expiry date is updated. Thus, the invention makes possible a payment network operating procedure which eliminates the cost of providing a new physical payment card at the expiry date of the card. Nevertheless, the operating procedure can be consistent with existing (and future) standards for operating a payment card network.

The updating of the expiry date is typically performed at a time proximate the expiry date (e.g. during a month at the end of which the payment card expires, or period of 1-2 months before the expiry of the payment card). At this time, any desired check on the status of the consumer is carried out, and subject to this check the expiry date of the card in the payment card record is updated to an “extended expiry date”. Optionally, any conditions on the use of the payment card (e.g. a credit limit, or a payment amount limit) may be revised at this time.

Optionally, the updating of the expiry date may be performed according to this procedure a plurality of times.

When the consumer wishes to make a payment, a payment authorization request is generated using the account data. Upon receiving the payment authorization request, a computer system with access to the database can use the card details to look up the expiry date. It may then check that the payment card has not expired. Note that no check is performed that the expiry data is included in the payment authorization request. The account data may be such as to indicate that this check is not performed. That is, for a payment card for which this check is not performed, the account number may be chosen to have a certain characteristic, for example being in a certain range.

The computer system which checks that the expiry date has not passed may be the payment card network server.

Alternatively, the computer system which checks that the expiry date has not passed may be associated with the issuing bank for the payment card.

To meet requirements of the existing payment card standard, the payment card be associated with an auxiliary date which is independent of the expiry date. Conveniently the auxiliary date may be an easily memorable date for the consumer, such as the consumer's month of birth. Alternatively, it may be a date which is notified to the consumer when the payment card is supplied to the consumer.

The auxiliary date is stored in an electro-magnetically (or, in alternatively, optically readable) element of the payment card, together with the account data for the card. When the card is used with a POS terminal or an ATM, the account data and auxiliary date is read by the POS terminal or ATM in the conventional manner.

For an online transaction to a merchant, the consumer enters the auxiliary date into a graphical user interface (GUI). Preferably, the auxiliary date is not visible on the payment card. The auxiliary date entered by the consumer is included in the payment authorization request, and compared with an auxiliary date stored in the database, to verify the identity of the user. This provides a level of security which is not present for a conventional online payment, which normally does not require the consumer to provide any information which is not printed on the card. Thus, this feature makes possible an anti-fraud measure which is not provided by known payment card network operating methods, while still being compatible with existing payment card standards.

Optionally, at least one CVV may be generated as a function of the account data and the auxiliary date stored on the payment card. It is stored by the payment card in an electromagnetically- or optically-readable element of the payment card. The CVV may be printed on the payment card. Optionally a first CVV value may be stored in a data storage element of the payment card which is only readable automatically (e.g. on a magnetic element of the card, such as a magnetic strip, or in an integrated-circuit smart card), and a second CVV value may be printed on the payment card.

As used in this document, the term “payment card” refers to any cashless payment device associated with a payment account, such as a credit card, a debit card, a prepaid card, a charge card, a membership card, a promotional card, a frequent flyer card, an identification card, a prepaid card, a gift card, and/or any other device that may hold payment account information (e.g. a key fob). The payment card has physical existence—that is, it is a “physical payment card”—in the sense that it exists as a physical object which a user can carry with him or her (e.g. in a wallet) and manipulate with his or her hands. It is typically printed with the account information. Thus, the payment card is not just a data structure in computer device, although the consumer may have the option to copy the account number of the payment card to a communication device (e.g. a mobile phone) so that the mobile phone may be used in place of the physical payment card for certain payment transactions.

The term “printed” is used in this document to mean that, if a data item is printed on the payment card, the item is permanently visible to a human reader (rather than an automatic data-reading device). The term covers, but is not limited to, the possibility that the item is permanently displayed on the payment card by depositing an ink formation encoding the item onto a surface of the payment card. The term embraces the possibility that the portion of the surface of the payment card where the item is visible was formed at the same time as the formation of the rest of the surface of the payment card.

As used in this application, the terms “component,” “module,” “engine,” “system,” “apparatus,” “interface,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. For instance, the claimed subject matter may be implemented as a computer-readable medium embedded with a computer executable program, which encompasses a computer program accessible from any computer-readable storage device or storage media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ).

In particular, the present disclosure can further be implemented as a computer system operative to perform a method. In other words, the computer system comprises a processor and a data storage device storing program instructions operable by the processor to cause the processor to perform the method.

### BRIEF DESCRIPTION OF THE EMBODIMENTS

Exemplary embodiments according to the present disclosure will now be described for the sake of example with reference to the following figures in which:

FIG. 1 shows schematically a known payment card network;

FIG. 2 shows a known payment card;

FIG. 3 shows an exemplary payment card;

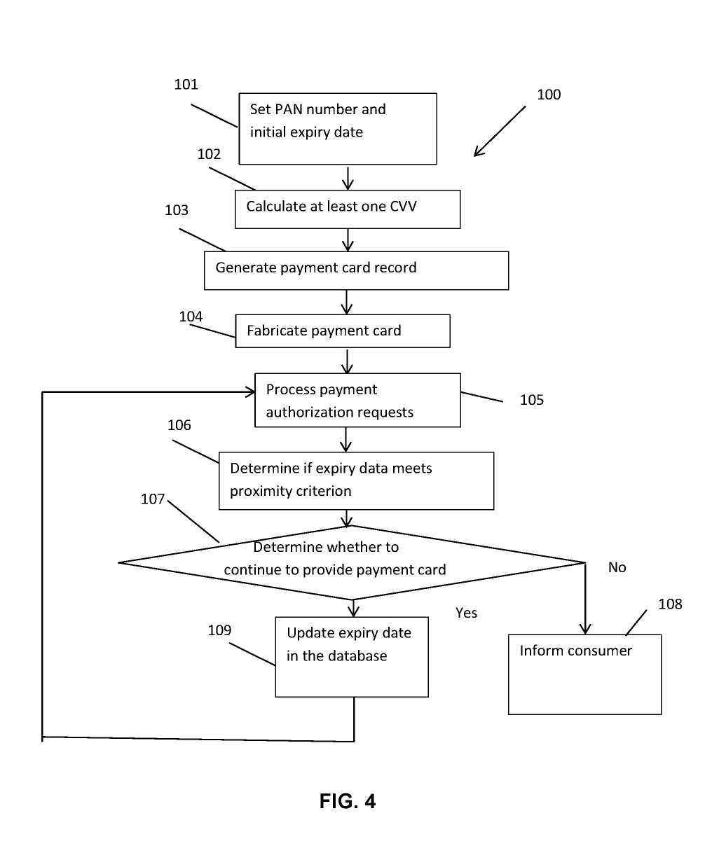

FIG. 4 shows the steps of a first exemplary method;

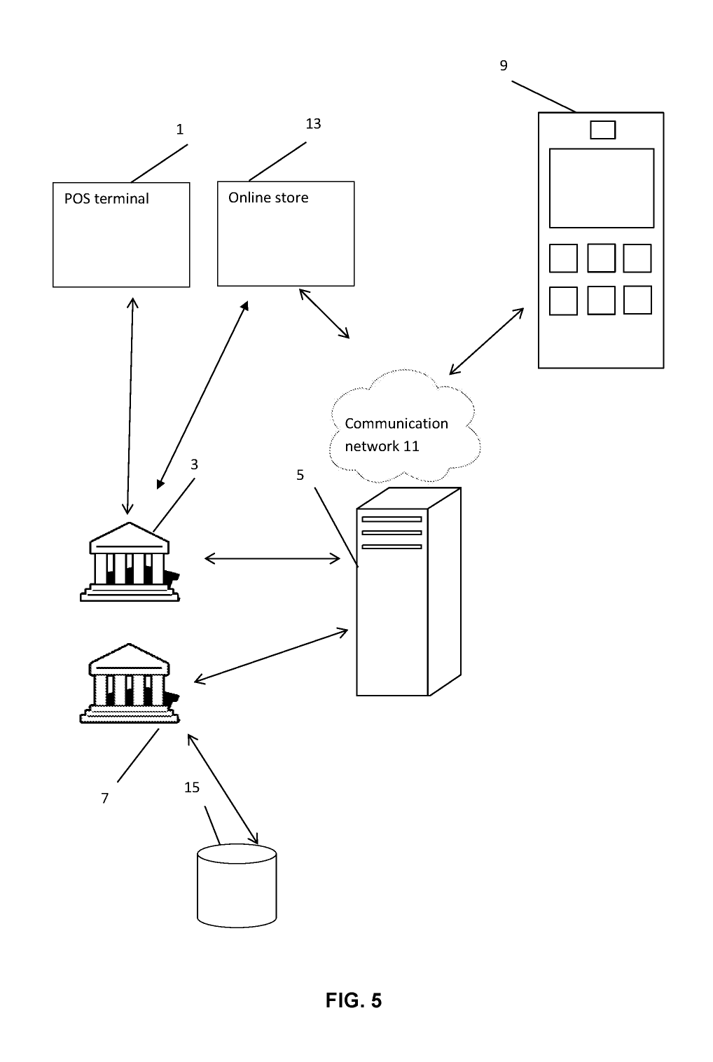

FIG. 5 shows schematically a first exemplary payment card network;

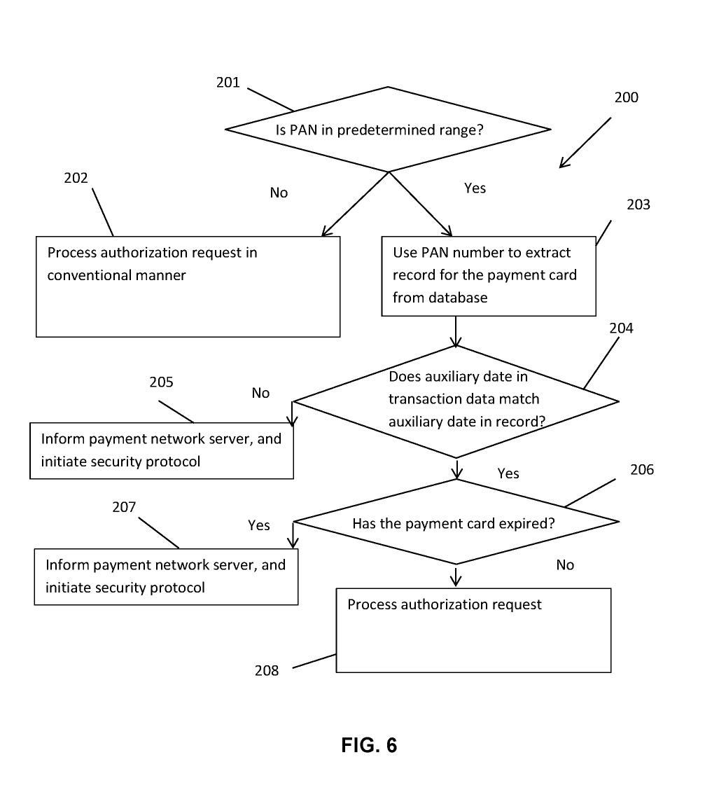

FIG. 6 shows the steps of a second exemplary method which may be employed by the payment card network of FIG. 5 in one step of the first exemplary method;

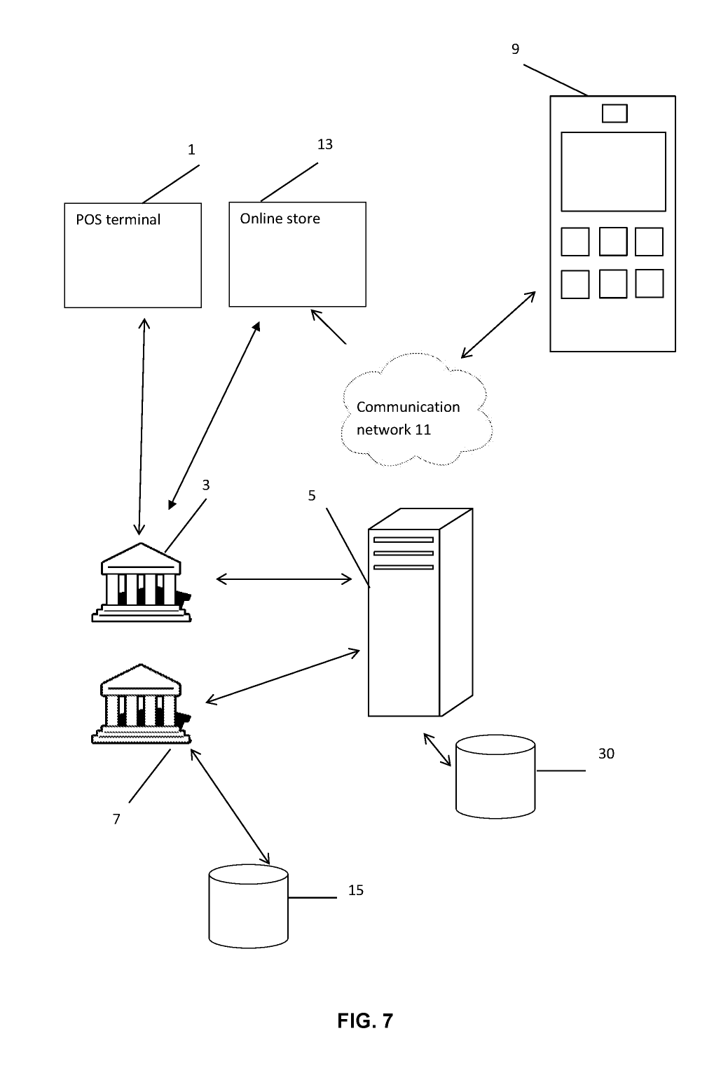

FIG. 7 shows schematically a second exemplary payment card network;

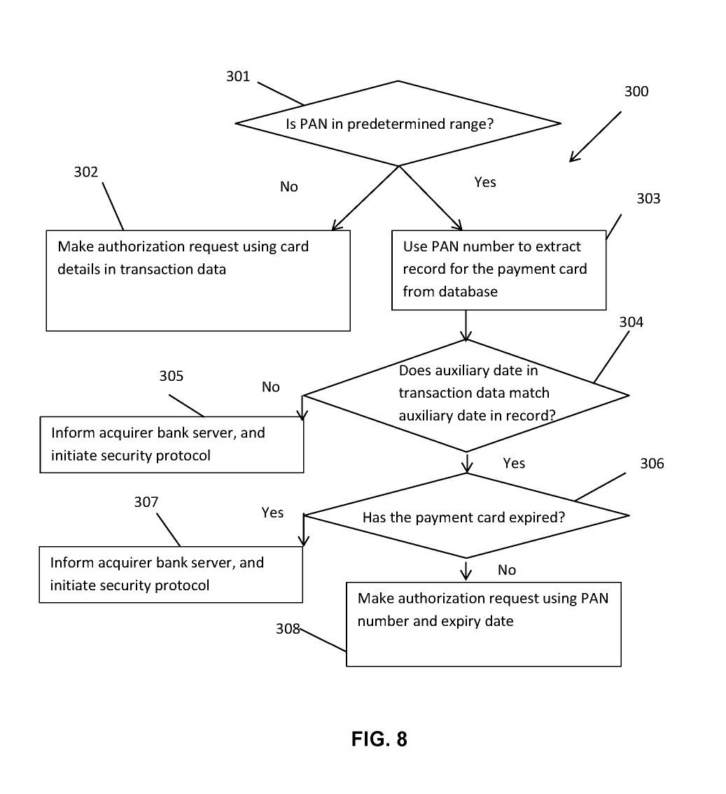

FIG. 8 shows the steps of a third exemplary method which may be employed by the payment card network of FIG. 7; and

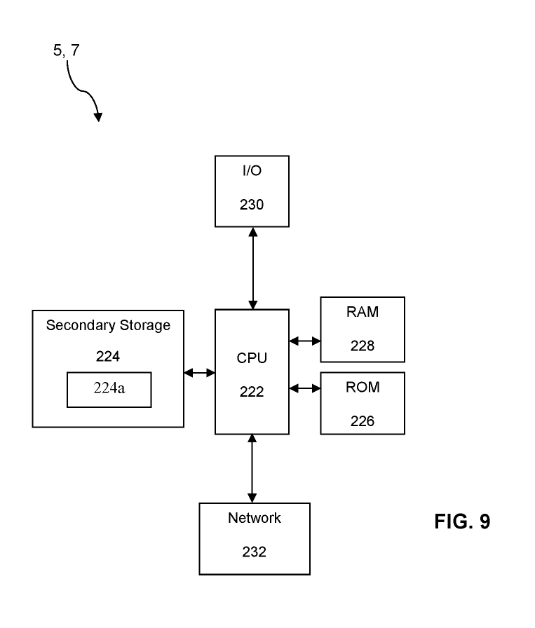

FIG. 9 shows the structure of a computer server of the payment card networks of FIGS. 5 and 7.

### DETAILED DESCRIPTION OF THE EMBODIMENTS

Referring to FIG. 3, an exemplary payment card 25 is illustrated. Superficially, the payment card 25 appears similar to the payment card 2 of FIG. 2. The payment card is planar, and on one surface displays a 16-digit account number 26 (PAN), which may be embossed. Also, there is CVV number 27 (which may be on the same surface of the payment card as the account number 26, or on the opposite surface). Preferably, the CVV number is printed, not embossed.

The payment card 25 includes an electromagnetically readable element (not shown). The electromagnetically readable element may be a magnetic strip or embedded integrated circuit, or possibly an optically-readable element, stores the PAN number, an auxiliary date and a CVV number (optionally the same as the printed CVV number 27, but more typically different).

The auxiliary date is known to the consumer, and may be a memorable month, such as the consumer's month of birth. The CVV is calculated from the auxiliary date and the PAN number, e.g. according to a known CVV-generation algorithm.

The method 100 by which the payment card 25 is created, and the expiry date is updated at intervals, is illustrated in FIG. 4.

In step 101, an issuer bank server sets the account number (PAN) of the card 25, and an initial expiry date of the card 25 by a conventional method. The issuer bank server also defines the auxiliary date as the consumer's month and year of birth. This information is typically present in the customer records of the issuer bank, and/or in an application form the issuer bank may ask the consumer to complete to obtain the payment card. Note that in variations of the invention, the issuer bank server may set another date as the auxiliary date, which is different from, and chosen independently of, the expiry date.

In step 102, the issuer bank server uses the auxiliary date and the account number of the payment card to generate at least one CVV value by a conventional algorithm.

In step 103, the issuer bank server generates a payment card record in a database (as explained below with reference to FIG. 5, the database is the one labelled 15 in FIG. 5). The payment card record includes the expiry date for the card, and also the auxiliary date and the at least one CVV value. The payment card record is accessible in the database using the account number 26.

In step 104, the issuer instructs a payment fabrication unit to fabricate the payment card 25. The fabricated payment card 25 is then transmitted to the consumer. If the auxiliary date is one generated by the issuer bank server, then the auxiliary date also is notified to the consumer.

In step 105, the issuer server processes any payment authorization requests it receives related to the payment card. This is done by the method of FIG. 6 explained below. It does not include checking whether the payment authorization request includes the expiry date.

Step 106 is performed periodically, e.g. once per month. The issuer bank server reviews the payment card record in the database to identify if the expiry date meets at least one proximity criterion (e.g. it is within a predetermined time window in the future, such as within the next 2 months).

If so, in step 107 the issuer bank server initiates a procedure (as in a conventional system) to determine whether to continue to provide payment card services to the consumer, and if so, whether the conditions of usage of the payment card (e.g. the credit card limit) should be changed.

If it is determined that payment card services should not continue to be provided to the consumer, then in step 108 the issuer bank server notifies the consumer.

If it is determined that payment card services should continue to be provided to the consumer, then in step 109 the issuer bank server updates the expiry date in the database, and sends a communication to the consumer notifying the consumer of the revised expiry date and any revisions to the conditions of usage of the payment card. Note that the issuer bank server does not have to send the consumer a revised CVV number, since the previously applicable number continues to be valid.

Note that in variation of the method 100, the issuer bank may use two servers. A first server performs steps 101-104 and 106-109, while a second server performs just step 105 using the database records generated and updated by the first server. This means that the second server is not given a load in addition to the load of performing step 105. In the following text, however, the two servers of the issuer bank are considered as a single computer system.

Turning to FIG. 5, a first exemplary computerized network is shown in which the payment card 25 can be used. Elements having the same meaning as in FIG. 1 are given the same reference numerals. In contrast to the known system of FIG. 1, the issuer bank server 7 has access to a database 15 containing records for respective payment cards. The database 15 is the one in which the payment card record was created during step 103 of the method 100 of FIG. 4, and the payment card record in the database 15 is updated each time step 109 is performed. Each record includes, and is identifiable using, the account number 26 of the payment card 25, and the record contains the payment card's expiry date and the auxiliary date.

Upon the consumer initiating a payment transaction using the POS terminal 1, the POS terminal reads the PAN number, auxiliary date and CVV from the electromagnetically-readable element of the payment card 25. The POS terminal 1 forms transaction data in the usual way. The transaction data includes the PAN number, the auxiliary date, the CVV, the amount of the proposed transaction and optionally other data. The POS terminal 1 forms a payment authorization request including the transaction data, and passes it to the acquirer server 3. In this step the POS terminal 1 operates in the same manner as a conventional POS terminal, although the data it handles has a different significance. The acquirer bank server 3 transmits the payment authorization request to the payment network server 5, as in the conventional process. The payment network server 5 transmits the payment authorization request to the issuer bank server 7 as in the conventional process.

Upon receiving the payment authorization request, the issuer bank server 7 performs the method 200 of FIG. 6. In step 201, the issuer bank server 7 determines whether the PAN number is in a predetermined range indicating that the payment card 25 is one according to the present disclosure. If not, the issuer bank server 7 processes the card according to the conventional procedure described above (step 202).

If the PAN number is in the predetermined range, in step 203 the issuer bank server 7 uses the PAN number to access the record for the payment card in the database 15.

In step 204, the issuer bank server 7 compares the auxiliary date in the transaction data with the auxiliary date in the record. If there is no match, then in step 205 the issuer bank server 7 indicates to the payment network server 5 that the payment transaction has failed. This information is relayed back to the POS terminal 1. The issuer bank server 7 updates a field of the record of the payment card in the database 15 which indicates the number of times this failure has happened. If the field indicates that this has happened more than a predetermined number of times, optionally, a security protocol may be initiated (e.g. the issuing bank server may cancel the card, i.e. marks the record for the payment card such that it will never again authorize a transaction using the payment card, and optionally issue a new payment card to the consumer).

Alternatively, if there was a match in step 204, the issuer bank server 7 proceeds to step 206, in which the issuer bank server 7 extracts the expiry date from the record, and checks whether the payment card has expired (i.e. the month indicated by the expiry date has finished). If the payment card has expired, the issuer bank server 7 indicates (step 207) to the payment network server 5 that the payment transaction has failed. Optionally, a security protocol may be initiated.

Alternatively, if the payment card has not expired, then in step 208 the issuer bank server 7 processes the authorization request according to the conventional authorization procedure described above. Optionally, the database 15 stores data sufficient for the issuer bank server 7 to do this (e.g. storing the balance of the financial account associated with the payment card); alternatively the database storing the data required to perform the authorization procedure may be a separate database. The issuer bank server 7 passes the result back to the payment network server 5 for relay to the POS terminal 1. The method 200 then terminates.

In the case that the consumer uses the payment card to make a purchase to the online store, the consumer enters the card details visible on the card into a GUI (graphical user interface) generated by the online store and displayed by the communication device 9 (either by the communication device 9 running a browser which communicates with the merchant server 13, or using a dedicated application running on the communication device 9). When prompted to enter a date, the consumer enters the auxiliary date (not the expiry date). The online server 13 then generates the payment authorization request according to the conventional procedure described above, and passes it to the acquirer bank server 3, which passes it to the payment network server 5, which passes it to the issuer bank server 7.

In this case too, the issuer bank server 7 performs the method 200, as described above. In this case, however, step 204 is more important, since it enables the issuer bank server 5 to verify the identity of the consumer (if it is assumed that no-one but the consumer knows the auxiliary date, which, as mentioned above, is not visible on the payment card 25).

Similarly, if the consumer attempts to withdraw money from an ATM (not shown) operated by the bank server 7, the ATM reads the account number 26, auxiliary date and expiry date from the payment card 25. The bank server 7 generates a payment authorization request, which is relayed to the issuer bank by the payment network server 5, and the issuer bank server 7 processes it by the process of FIG. 6. The result is relayed back to the bank server 7 via the payment network server 5, and the ATM provides money to the consumer accordingly.

Turning to FIG. 7, a second exemplary computerized network is shown in which the payment card 25 can be used. Elements having the same meaning as in FIGS. 1 and 5 are given the same reference numerals. In contrast to the exemplary system of FIG. 5, the payment network server 5 has access to a database 30 containing records for respective payment cards. The database 30, like the database 15, stores records for each payment card 25. Each record includes, and is identifiable using, the payment card's PAN number, and the record contains the payment card's expiry date and the auxiliary date. Thus, the database 30 mirrors the database 15. Like the database 15, the database 30 may be created during step 103 of the method 100 of FIG. 4, and updated each time step 109 is performed. In a variation of the payment card network of FIG. 7, the databases 15, 30 are combined into a single database which is accessed by both the payment card server 5 and the issuer bank server 7.

Upon the consumer initiating a payment transaction using the POS terminal 1, the POS terminal reads the PAN number, auxiliary date and CVV from electromagnetically-readable medium. The POS terminal 1 forms a payment authorization request in the manner described above with reference to FIG. 4, and passes it to the acquirer server 3, which transmits the payment authorization request to the payment network server 5.

The payment network server 5 performs the method 300 of FIG. 8. In step 301, the payment network server 5 determines whether the PAN number is in a predetermined range indicating that the payment card is one according to the present disclosure. If not, the payment network server 5 processes the card according to the convention procedure described above (step 302), by forwarding it to issuer bank server 7.

If the PAN number is in the predetermined range, in step 303 the payment network server 5 uses the PAN number to access the record for the payment card in the database 30.

In optional step 304, the payment network server 5 compares the auxiliary date in the transaction data with the auxiliary date in the record. If there is no match, the payment network server 5 indicates to the acquiring bank server 3 (step 305) that the payment transaction has failed. Optionally, a security protocol may be initiated (e.g. the issuing bank may be informed that the payment card has been compromised).

Alternatively, if there was a match in step 304, the payment network server 5 proceeds to step 306, in which the payment network server 5 extracts the expiry date from the record, and checks whether the payment card has expired (i.e. the expiry date is in the past). If the payment card has expired, the payment network server 5 indicates (step 307) to the acquiring bank 3 that the payment transaction has failed. Optionally, a security protocol may be initiated (e.g. the issuing bank may be informed that someone has attempted to use an expired card).

Alternatively, if the payment card has not expired, then in step 308 the payment network server 5 forwards the payment authorization request to the issuing bank server 7. The issuing bank server determines whether to authorize the payment, and passes a corresponding message to the payment network server 5 which relays it to the acquirer bank 3, which relays it to the POS terminal 1. The method 300 then terminates.

In the case that the consumer uses the payment card to make a purchase to the online store, the consumer enters the card details visible on the card into a GUI generated by the online store and displayed by the communication device 9 (either by the communication device 9 running a browser which communicates with the merchant server 13, or using a dedicated application running on the communication device 9). When prompted to enter a date, the consumer enters the auxiliary date (not the expiry date). The online server 13 then generates the payment authorization request according to the conventional procedure described above, and passes it to the acquirer bank server 3, which passes it to the payment network server 5.

In this case too, the payment network server performs the method 300, as described above. In this case, however, step 304 enables the payment network server 5 to verify the identity of the consumer (if it is assumed that no-one but the consumer knows the auxiliary date, which, as mentioned above, is not visible on the payment card 25).

Similarly, if the consumer attempts to withdraw money from an ATM (not shown) operated by the bank server 7, the ATM reads the account number 26, auxiliary date and expiry date from the payment card 25. The bank server 7 generates a payment authorization request and sends it to the payment network server 5 which performs the method of FIG. 8. In step 308, the payment network server 5 relays the payment authorization request to the issuer bank. The issuer bank server 7 processes it by the conventional payment authorization process. The result is relayed back to the bank server 7 via the payment network server 5, and the ATM provides money to the consumer accordingly.

Note that in contrast to the method 200, the load on the issuing bank server 7 is less if the payment network server 5 has carried out method 300, since the payment network server 5 filters out any payment authorization requests in respect of payment cards which have not expired, or which do not contain a correct auxiliary date. Furthermore, since, in the method 300, the checks that the auxiliary date in the transaction data matches the payment card record, and that the expiry date has not passed, have been done in the payment network server 5, the issuer bank server 7 does not have to perform the whole of the method 200, but only the step 208.

Whenever step 108 of the method 100 is carried out by the issuer bank server 7, the issuer bank server 7 notifies the payment network server 5, and the payment network server 5 updates the database 30 accordingly. Thus, the payment network server 5 processes further payment authentication requests after the databases 15, 30 are updated.

FIG. 9 is a block diagram showing a technical architecture of the payment network server 5. The issuer bank server 7 may also have this technical architecture.

The technical architecture includes a processor 222 (which may be referred to as a central processor unit or CPU) that is in communication with memory devices including secondary storage 224 (such as disk drives), read only memory (ROM) 226, random access memory (RAM) 228. The processor 222 may be implemented as one or more CPU chips. The technical architecture may further comprise input/output (I/O) devices 230, and network connectivity devices 232.

The secondary storage 224 is typically comprised of one or more disk drives or tape drives and is used for non-volatile storage of data and as an over-flow data storage device if RAM 228 is not large enough to hold all working data. Secondary storage 224 may be used to store programs which are loaded into RAM 228 when such programs are selected for execution.

In this embodiment, the secondary storage 224 has a processing component 224a comprising non-transitory instructions operative by the processor 222 to perform various operations of the method of the present disclosure. The ROM 226 is used to store instructions and perhaps data which are read during program execution. The secondary storage 224, the RAM 228, and/or the ROM 226 may be referred to in some contexts as computer readable storage media and/or non-transitory computer readable media.

I/O devices 230 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Although the technical architecture is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 220 to provide the functionality of a number of servers that is not directly bound to the number of computers in the technical architecture 220. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It is understood that by programming and/or loading executable instructions onto the technical architecture, at least one of the CPU 222, the RAM 228, and the ROM 226 are changed, transforming the technical architecture in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Whilst the foregoing description has described exemplary embodiments, it will be understood by those skilled in the art that many variations of the embodiment can be made within the scope and spirit of the present invention.

1. A computer-implemented method for operating a payment card network, the method including:
(a) at least once performing the set of steps of:
(i) receiving a payment authorization request comprising account data identifying a payment card; and
(ii) accessing a database using the account data to obtain a payment card record for the payment card, obtaining an expiry date in the payment card record, determining if the expiry date has passed, and rejecting the payment authorization request if the determination is positive;
(b) at a time after performing step (a), updating the payment card record by replacing the expiry date with an extended expiry date which is later than the expiry date; and
(c) at least once, at a time after performing step (b), performing the set of steps of:
(i) receiving a further payment authorization request comprising the account data; and
(ii) without verifying whether the further payment authorization request comprises data encoding the extended expiry date, accessing the database using the account data to obtain the payment card record for the payment card, obtaining the extended expiry date in the payment card record, determining if the extended expiry date has passed, and rejecting the payment authorization request if the determination is positive.

2. A computer-implemented method for operating a payment card network, the method including:
(a) at least once performing the set of steps of:
(i) obtaining account data from a physical payment card, the account data identifying a payment card;
(ii) generating a payment authorization request comprising the account data;
(iii) transmitting the payment authorization request; and
(iv) accessing a database using the account data to obtain a payment card record for the payment card, obtaining an expiry date in the payment card record, determining if the expiry date has passed, and rejecting the payment authorization request if the determination is positive;
(b) at a time after performing step (a), updating the database by replacing the initial expiry date with an extended expiry date which is later than the expiry date; and
(c) at least once, at a time after performing step (b), performing the set of steps of:
(i) obtaining the account data from the physical payment card,
(ii) generating a further payment authorization request comprising the account data; and
(iii) accessing the database using the account data to obtain the payment card record for the payment card, obtaining the extended expiry date in the payment card record, determining if the extended expiry date has passed, and rejecting the further payment authorization request if the determination is positive.

3. A computer-implemented method according to claim 1, further including:
prior to performing step (a), fabricating the payment card storing the account data, and storing the expiry date in the corresponding payment card record;
at intervals determining whether the expiry date meets a proximity criterion, and upon the determination being positive:
determining whether the consumer meets one or more criteria; and
if the consumer meets the one or more criteria, performing said step (b) of updating the database by replacing the expiry date with the extended expiry date.

4. A method according to claim 3 in which said step of fabricating the payment card does not include storing the expiry date on the payment card.

5. A method according to claim 1, in which in the further payment authorization request comprises an auxiliary date different from the expiry date, the method comprising determining whether the auxiliary date differs from an auxiliary date in the payment card record, and rejecting the payment authorization request if the determination is positive.

6. A method according to claim 3, in which in the further payment authorization request comprises an auxiliary date different from the expiry date, the method comprising determining whether the auxiliary date differs from an auxiliary date in the payment card record, and rejecting the payment authorization request if the determination is positive, wherein the step of fabricating the payment card includes encoding the auxiliary date in the payment card in an electro-magnetically or optically-readable element of the payment card.

7. A method according to claim 6 in which the electro-magnetically or optically-readable element of the payment card is a magnetic element or an integrated circuit smart card.

8. A method according to claim 6 further including forming at least one card verification value using the auxiliary date and the account data, and storing the card verification value in the payment card.

9. A computer system operative to:
(i) receive a payment authorization request comprising account data identifying a payment card; and
(ii) without verifying whether the payment authorization request comprises data encoding an expiry date, access a database using the account data to obtain a payment card record for the payment card, obtain an expiry date in the payment card record, determine if the obtained expiry date has passed, and reject the payment authorization request if the determination is positive.

10. A computer system according to claim 9, which is further operative to determine whether an auxiliary date in the payment authorization request matches an auxiliary date in the payment card record which differs from the expiry date, and reject the payment authorization request if the determination is negative.

11. A computer system according to claim 9 which is further operative to:
initiate the fabrication of the payment card storing the account data;
store the expiry date in the corresponding payment card record;
at intervals determine whether the expiry date meets a proximity criterion, and upon the determination being positive:
determine whether the consumer meets one or more criteria; and
if the consumer meets the one or more criteria, update the payment card record by replacing the expiry date with the extended expiry date.

12. A computer system according to claim 11, which is further operative to cause the auxiliary date to be stored in the payment card.

13. A computer system according to claim 12 which is further operative to form at least one card verification value using the auxiliary date and the account data, and cause the at least one card verification value to be stored in the payment card.

14. A computerized payment card network, the network including:
(a) a merchant device operative to:
(i) obtain account data from a physical payment card, the account data identifying a payment card;
(ii) generate a payment authorization request comprising the account data; and
(iii) transmit the payment authorization request;
(b) a computer system operative to, without verifying whether the payment authorization request comprises data encoding the extended expiry date, access a database using the account data to obtain a payment card record for the payment card, obtain the extended expiry date in the payment card record, determine if the extended expiry date has passed, and reject the payment authorization request if the determination is positive.

15. A computerized network according to claim 14, in which the computer system is further operative to determine whether an auxiliary date in the payment authorization request matches an auxiliary date in the payment card record which differs from the expiry date, and reject the payment authorization request if the determination is negative.

16. A computerized network according to claim 14, further including a payment card fabrication unit, the computer system being further operative to:
control the payment card fabrication unit to initiate fabrication of the payment card storing the account data;
store the expiry date in the corresponding payment card record;
at intervals determine whether the expiry date meets a proximity criterion, and upon the determination being positive:
determine whether the consumer meets one or more criteria; and
if the consumer meets the one or more criteria, update the payment card record by replacing the expiry date with the extended expiry date.

17. A computerized network according to claim 16, in which the computerized system is further operative to control the payment card fabrication unit to store the auxiliary date in the payment card.

18. A computerized network according to claim 17 in which the computer system which is further operative to form at least one card verification value using the auxiliary date and the account data, and control the payment card fabrication unit to store the at least one card verification value in the payment card.
